(19) United States
(12) Patent Application Publication
(10) Pub. No.: US 2006/0139238 A1
(43) Pub. Date: Jun. 29, 2006

(54) Light emitting display device and method of driving the same

(75) Inventors: Toru Chiba, Tokyo (JP); Takanobu Shiokawa, Kanagawa (JP); Takaomi Sekiya, Tokyo (JP); Yukio Kubota, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/318,609

(22) Filed: Dec. 28, 2005

(30) Foreign Application Priority Data
Dec. 28, 2004 (JP) P2004 - 378966

(51) Int. Cl. G09G 3/06; G09G 3/32

(52) U.S. Cl. 345/44; 345/82

(57) ABSTRACT

A unit quantity of electricity is input to each pixel of a plurality of pixels according to image data so that the each pixel emits a predetermined light. The luminance of the predetermined light per unit quantity of electricity is smaller as electric resistance value of each pixel become larger. A high resistance pixel having a relatively high electric resistance value or a low resistance pixel having a relatively low electric resistance value is detected among the plurality of pixels. The unit quantity of electricity is adjusted for at least one of the high resistance pixel and the low resistance pixel.

### BACKGROUND OF THE INVENTION

1. Field of the Invention

The present invention relates to a light emitting display device having an emitting device such as an organic electroluminescent device.

2. Description of the Related Art

Recently, light emitting display devices using organic electroluminescent devices (hereafter “EL device”) have been developed as the EL display devices. EL display devices have several superior properties for example, high response speed, wide angle field of vision, not needing back lighting, and occupying a small space.

Conventionally, there are two methods of driving an EL display device, the passive matrix driving method and the active matrix driving method.

The passive matrix display comprises a plurality of scanning electrodes and a plurality of signal electrodes which are crossed with the scanning electrodes. The pixels of the display are formed by a part of the EL device at the intersections of the scanning electrodes and the signal electrodes.

In the passive matrix method, one of the plurality of scanning electrodes is switched on, and the electric current is input to the signal electrodes according to the image data. Light from the pixel at the intersection of the scanning electrode which is switched on, and the signal electrodes where the electric currents is input is emitted, so that one line of the image data is displayed. The scanning electrode is continuously switched on in the vertical direction, and then when all scanning electrodes finish switching on, the one frame (or field) image is displayed on the EL display device.

On the other hand, the active matrix display has a switching device and a storage capacitor which are integrated at the each intersection of the electrodes. The integrated switching devices use transistors made or deposited thin films, which are called thin-film transistors (TFT). Due to these switching devices, the electric current which is input to each pixel is independently adjusted, therefore, each pixel is capable of emitting light independently.

In both passive and active matrix displays, the luminance of each pixel is determined by adjusting the electric current value input in each pixel, therefore, electric current having the same value is input to the pixels having the save pixel luminance value.

However, the effectiveness of the EL device becomes deteriorates and the luminous efficiency of pixels of the EL device becomes different, as the emitting time elongated. Therefore, when a particular pixel emits light for longer than other pixels, for example when the same image is displayed at the same position on the monitor, the luminous efficiency of that particular pixel is different to the other pixels. In this case, the luminance of light which is emitted by the particular pixel is lower than that which is emitted by the other pixels, even if the same electric current is input to all the pixels. Accordingly, uniformity in the luminance is usually lacking on the display panel if it is used for a long time.

The conventional method for maintaining uniform luminance is shown in Japanese Unexamined Patent Publication (KOKAI) No. 2003-228329. In this method, the output values of the image signals are integrated for each pixel while the image is being displayed on the display panel. On the other hand, while the image is not being displayed on the display panel, light from tho pixels having a relatively small integration value for the output values is emitted, so that the integration of the output values regarding all pixels is adjusted to the same integration. Namely, in this method, the luminance levels of pixels, which have not fallen so much because of a relatively short emitting time are intentionally lowered, so that the luminance levels of all pixels are changed to the same level.

However, in this method the display panel has to be driven while the display panel is not used, therefore, the electrical power is unnecessarily consumed. Furthermore, the output value of each pixel for all the pixels has to be integrated in order to confirm to what extent each pixel has deteriorated, therefore the process of this method becomes complicated.

### SUMMARY OF THE INVENTION

Therefore, an object of the present invention is to provide a light emitting display device which maintains uniform luminance by using a simple driving system.

According to the present invention, there is provided a light emitting display device which has a display panel, an input processor, and a detecting processor. The display panel comprises an emitting device which forms a plurality of pixels. The input processor inputs a unit quantity of electricity in each pixel of the plurality of pixels according to image data so that the each pixel emits a predetermined light. The luminance value of the predetermined light per unit quantity of electricity becomes smaller as electric resistance value of the each pixel becomes larger. The detecting processor detects at least one of a high resistance pixel having a relatively high electric resistance value and a low resistance pixel having a relatively low electric resistance value among the plurality of pixels. Then, the input processor adjusts the unit quantity of electricity for at least one of the high resistance pixel and the low resistance pixel. The unit quantity of electricity supplied to the high resistance pixel is increased relative to the unit quantity of electricity supplied to the low resistance pixel, or the unit quantity of electricity supplied to the low resistance pixel is decreased relative to the unit quantity of electricity supplied to the high resistance pixel. The detecting processor preferably measures the value of electric resistance for each pixel, in order to detect at least one of the high resistance pixel and the low resistance pixel. The detecting processor measures a voltage of each pixel so as to obtain the electric resistance, when a standard electric current is input therein for example. The detecting processor measures the electric current value through each pixel so as to obtain the value of the electric resistance, when a standard voltage is applied thereto for example.

The input processor preferably increases the unit quantity of electricity in a high resistance pixel. Further, the input processor preferably decreases the unit quantity of electricity in the low resistance pixel for example. The input processor increases the unit quantity of electricity in the high resistance pixel, and decreases the unit quantity of electricity in the low resistance pixel for example.

The light emitting display device optionally has a memory that stores a relation data between the luminance value and the electric resistance value. When the relation data is previously stored, the relation data is generated based on the luminance which is measured when the electric resistance value is changed for example. Preferably, the input processor adjusts the unit quantity of electricity, based on the relation data and the electric resistance value measured by the detecting processor, for each pixel.

The light emitting display device optionally has a data generation processor that generates a correction value regarding the each pixel. The correction value is larger as the electric resistance value is larger. In this case, the unit quantity of electricity in each pixel which is determined according to the image data, is multiplied by the correction value.

Preferably, the luminance value, which corresponds to each the electric resistance value of the emitting device, is measured prior to operation of the device, and the input processor can adjust the unit quantity of electricity based on the measured luminance value.

Preferably, the unit quantity of electricity is a quantity of electricity input to the each pixel for a predetermined time. The predetermined time is within a period where the display panel displays one-frame image for example. When the method of driving the EL display device is the passive matrix driving method, the predetermined time is the time for scanning one-line of image data, for example.

According to the present invention, there is provided a method of driving a light emitting display device. The light emitting display device comprises a display panel having an emitting device which forms a plurality of pixels. The driving method comprises a first, second and third step.

The first step is inputting a unit quantity of electricity to each pixel of the plurality of pixels according to image data so that each pixel emits a predetermined light. The luminance of the predetermined light per unit quantity of electricity becomes smaller as the electric resistance value of the each pixel becomes larger. The second step is detecting at least one of a high resistance pixel having a relatively high electric resistance value and a low resistance pixel having a relatively low electric resistance value among the plurality of pixels. The third step is adjusting the unit quantity of electricity for at least one of the high resistance pixel and the low resistance pixel. In this case, unit quantity of electricity supplied to the high resistance pixel is increased relative to the unit quantity of electricity supplied to the low resistance pixel, or the unit quantity of electricity supplied to the low resistance pixel is decreased relative to the unit quantity of electricity supplied to the high resistance pixel.

According to the present invention, there is provided a light emitting display device has a display panel, an input processor, and a detecting processor. The display panel has an emitting device which forms a plurality of pixels. The input processor inputs a unit quantity of electricity to each pixel of the plurality of pixels according to image data so that each pixel emits a predetermined light. The luminance of the predetermined light per unit quantity of electricity becomes smaller as the electric resistance value of the each pixel becomes larger. The detecting processor measures an electric resistance value of each pixel of the plurality of pixels.

### BRIEF DESCRIPTION OF THE DRAWINGS

The objects and advantages of the present invention will be better understood from the following description, with reference to the accompanying drawings in which:

FIG. 1 is a block diagram, showing the light emitting display device to which a first embodiment of the present invention is applied,

FIG. 2 is a circuit diagram, showing the equivalent circuit of the unit EL device,

FIG. 3 is a schematic view, showing the process for displaying the image data,

FIG. 4 is the flowchart showing the routine for calculating the correction data,

FIG. 5 is the flowchart showing the routine for displaying the image data on the display panel, and

FIG. 6 is a graph showing the relation between the voltage value and the luminous efficiency.

### DESCRIPTION OF THE PREFERRED EMBODIMENTS

The present invention will be described below with reference to the embodiments shown in the drawings.

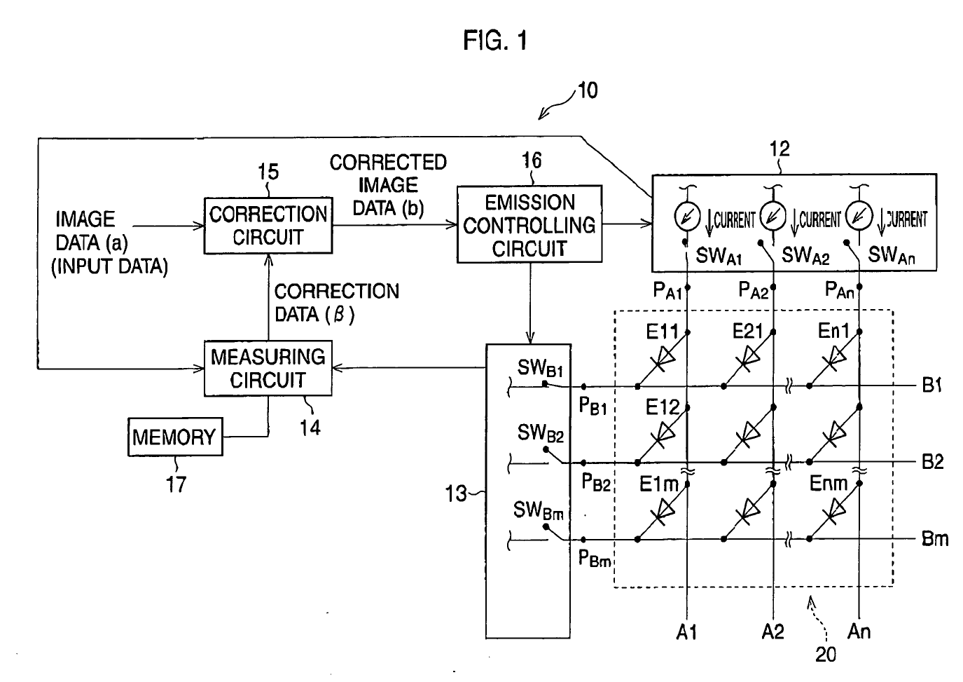

FIG. 1 is a block diagram, showing the light emitting display device to which a first embodiment of the present invention is applied.

The light emitting display device 10 has a display panel 20, which is driven by using the passive matrix driving method. The display panel 20 has a plurality of anode lines A1-An as the signal electrodes and a plurality of cathode lines B1-Bm as the scanning electrodes. The plurality of anode lines A1-An extending in the vertical direction, crosses the plurality of cathode lines B1-Bm extending in the horizontal direction.

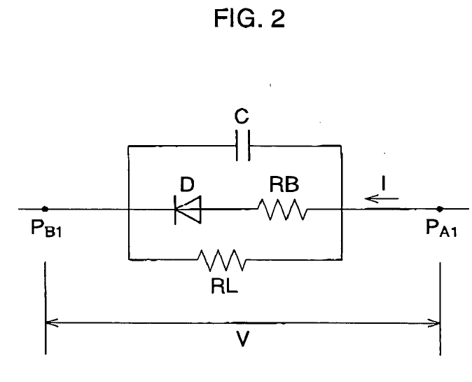

The display panel 20 has an EL device, which is disposed between the plurality of anode lines A1-An and the plurality of cathode lines B1-Bm. The electric current is input to each part of the EL device at intersections of the anode lines A1-An and each of the cathode lines B1-Bm, so that the parts of the EL device at the intersections are composed of unit EL devices E11-Enm respectively. Namely, both ends of each unit EL device E11-Enm are respectively connected to one of the anode lines A1-An and one of the cathode lines B1-Bm at each intersection of the cathode and anode line as shown in FIG. 1. Due to this, each pixel in the display panel 20 comprises a unit EL device E11-Enm. The unit EL devices E11-Enm are shown as the diode symbol in FIG. 1, however the equivalent circuit of the unit EL device is shown in FIG. 2 as described below.

The anode lines A1-An are connected to an anode driving circuit 12 and are driven thereby. The cathode lines B1-Bm are connected to a cathode driving circuit 13 and are driven thereby. In the anode driving circuit 12, the anode lines A1-An are respectively provided with switches Swₐ₁-Swₐₙ, which are controlled by the anode driving circuit 12. Similarly, in the cathode driving circuit 13, the cathode lines B1-Bm are respectively provided with switches Sw_{B1}-Sw_{Bm} which are controlled by the cathode driving circuit 13.

The light emitting display device 10 has a measuring circuit 14, which is connect to the anode driving circuit 12 and the cathode driving circuit 13. The measuring circuit 14 is capable of measuring the electric potential difference between two points P_{B1}-P_{A1}, P_{B1}-P_{A2}, . . . , or P_{Bm}-P_{An} so as to measure the electric potential difference (voltage value) between both ends of the unit EL devices E11-Enm.

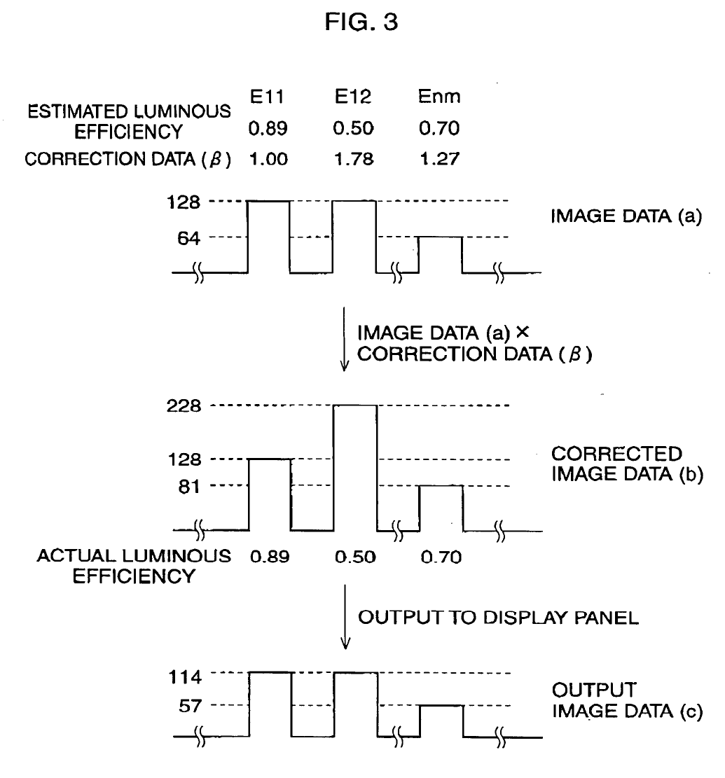

For example, when the power supply in switched on, the voltage value of each unit EL device E11-Enm is measured in a state where the standard electric current I_{c} is input to each of the unit EL devices E11-Enm. Due to this, the electric resistance value of each of the unit EL devices E11-Enm is measured. The measuring circuit 14 estimates the luminous efficiency of each of the unit EL devices E11-Enm, based on the measured electric resistance value of each pixel. The measuring circuit 14 calculates the correction data for correcting image data (a) (FIG. 3) regarding each of the unit EL devices E11-Enm (namely, each pixel), based on the estimated luminous efficiency. The correction data is stored in the measuring circuit 14. Further, the estimated luminous efficiency is estimated based on a table (as shown in Table 2) which was previously stored in the memory 17 when the light emitting display device 10 was manufactured.

After the correction data is calculated, the image data (a) is input to the light emitting display device 10, and the image corresponding to the image data starts to be displayed on the display panel 20.

The image data which is input to the device 10 is input to the correction circuit 15 at first. At the correction circuit 15, the image data (a) is corrected by the correction data (β) which is input from the measuring circuit 14, so as to be converted to corrected image data (b). In this case, the correction data (β) is calculated based on the electric resistance value of each unit EL device E11-Enm as described above, namely image data of each the pixel is corrected according to the electric resistance value of each pixel. The corrected image data (b) is input to an emission controlling circuit 16, and is converted to driving control data therein. The driving control data is input the anode driving circuit 12 and the cathode driving circuit 13. At the anode driving circuit 12 and the cathode driving circuit 13, the switches Sw_{A1}-Sw_{An} and Sw_{B1}-Sw_{Bm} are controlled by the driving control data, and the unit quantity of electricity which is input to the each anode line A1-An is determined by the driving control data.

One cathode line is selected as the selected cathode line Bx from the plurality of the cathode lines B1-Bm. Then one of the switches Sw_{B1}-Sw_{Bm} which is provided on the selected cathode line Bx is changed to on, and current can then flow through the selected cathode line Bx. On the other hand, the anode driving circuit 12 changes the switches Sw_{A1}-Sw_{An}, to the ON-state or OFF-state, and inputs the electric current to the anode lines A1-An of which the switches Sw_{A1}-Sw_{An} are set to the ON-state by the driving control data.

The cathode lines B1-BM are continuously scanned in the vertical direction. Namely the selected cathode line Bx is changed from the first cathode line B1 to the last cathode line Bm in the vertical direction. The electric current is input to the unit EL devices E1x-Enx which are disposed at the intersections of the selected cathode lines Bx and the anode lines A1-An where the electric current is input. When all cathode lines B1-Bm have finished being scanned, one-frame (or one-field) image is displayed on the display panel 20.

While one selected cathode line Bx is selected, the predetermined electric current is input to each unit EL device E1x-Enx of which switches Sw_{A1}-Sw_{An} are changed to the ON-state, for the predetermined time, so as to input the unit quantity of electricity to each unit EL device E1x-Enx. In this case, the unit quantity of electricity means the sum of the quantity of electricity which is input to each unit EL device E1x-Enx for the predetermined time. The unit EL devices E1x-Enx emit light corresponding to the input unit quantity of electricity. Further, in this embodiment, the predetermined time is the period where one cathode line is scanned.

The electric current which is input to each unit EL device E1x-Enx is input as a pulse signal, therefore the input unit quantity of electricity is preferably determined by adjusting the height of the pulse signal (namely, electric current value). Of course, the input unit quantity of electricity can be determined by adjusting the duty ratio of the pulse signal.

FIG. 2 shows the equivalent circuit of an unit EL device. The equivalent circuit is indicated as a parallel circuit which have a diode D and resistor RB connected in series, a capacity C, and a resistor RL. In the equivalent circuit, the resistance value of the resistance RL is infinitesimal and it does not need to be taken in to account, because the resistance RL is the resistance when the electric current flows in the reverse direction. Therefore, the resistance value of the resistance RB of the unit EL device is V/I when the electric potential difference between both ends of the unit EL device is “V” and the electric current which is input to the unit EL device is “I”.

Table 1 shows the emitting characteristics of each unit EL device. The emitting characteristics of the EL device of this embodiment have been previously determined. In this determination process, an EL device having the same structure as the EL device of this embodiment was prepared. The standard electric current I_{c} (2.5 mA/cm²) was continuously input to this prepared EL device, so as to continuously emit light for the emitting times shown in Table 1. In this situation, the electric voltage value, the luminance value, and the luminous efficiency were measured for each emitting time, as shown in Table 1. Further, the luminous efficiency is indicated as a ratio, when the luminous efficiency, at the initial situation (when the emitting time is 3 hours) is indicated as 1.00.

The results indicate that the luminance value and the luminous efficiency become lower as the emitting time becomes longer, but the electric voltage value becomes higher as the emitting time becomes longer as shown in Table 1. The increase in the electric voltage shown in the results means an increase in the resistance of the EL device, because the relation between the electric voltage and the resistance ie at RB-V/I(I_{c}). Therefore, the data indicates that the luminous efficiency becomes lower, as the electric resistance becomes higher in the EL unit device. In other words, the unit EL device which has a emitted light for a long time has deteriorated; therefore, the luminous efficiency is low.

TABLE 1

| Emitting | Voltage | Luminance | Luminous |
|---|---|---|---|
| Time (hours) | Value (V) | Value (cd/m2) | Efficiency |
| 3 | 7.7 | 1849 | 1.00 |
| 14 | 8.0 | 1649 | 0.89 |
| 30 | 8.1 | 1535 | 0.83 |
| 66 | 9.2 | 1414 | 0.77 |
| 136 | 9.3 | 1361 | 0.74 |
| 230 | 8.4 | 1302 | 0.70 |
| 330 | 9.6 | 1252 | 0.69 |
| 390 | 8.6 | 1217 | 0.66 |
| 510 | 8.7 | 1130 | 0.61 |
| 630 | 8.8 | 1048 | 0.57 |
| 750 | 8.9 | 984 | 0.53 |
| 900 | 9.0 | 926 | 0.50 |
| 1295 | 9.1 | 947 | 0.46 |
| 1500 | 9.2 | 784 | 0.42 |

Further, the same image is sometimes displayed at the same position on the display panel 20. In this case, the some unit EL devices emit for a longer time than others and hence have lower luminous efficiency than the other unit EL devices. Therefore, the specified unit EL devices emit darker light than the other unit EL devices. Due to this, all the unit EL devices emit light which does not have a uniform luminance when the same electric current is input all the unit EL devices.

On the other hand, all the unit EL devices have the same structure and have the same emitting characteristics, because they are the parts of the same EL device. Therefore, the relation between the resistance value (the voltage value when the same electric current is input) and the luminous efficiency is the same as that shown in Table 1 regarding all the unit EL devices. Accordingly, the luminous efficiency of the unit EL devices can be estimated by measuring the electric resistance of each unit EL device.

Therefore, in this embodiment, the data which shows of the relation between the electric resistance (the voltage value when the same electric current is input to each unit EL device) and the luminous efficiency as shown in Table 2 is generated and is stored in the memory 17 when the light emitting display device 10 is being constructed.

In this embodiment, the resistance values of all unit EL devices E11-Enm are measured every time the power supply is switched on. And the luminous efficiencies of all the unit EL devices are estimated using the measured resistance values (the voltage value when the same electric current is input) shown in Table 2. After that, the electric current is input to the unit EL devices E11-Enm according to the image data (a), while increasing the electric current input to some of the unit EL devices E11-Enm of which the luminous efficiency is estimated to be relatively low. Due to this, even if the luminous efficiencies of some of the unit EL devices E11-Enm become different, the input value of the image data is precisely controlled regarding the luminance for the image which is displayed on the display panel 20.

TABLE 2

| Voltage | Estimated Luminous |
|---|---|
| value* (V) | Efficiency |
| 7.7 | 1.00 |
| 8.0 | 0.89 |
| 8.1 | 0.83 |
| 8.2 | 0.77 |
| 8.3 | 0.74 |
| 8.4 | 0.70 |
| 8.5 | 0.68 |
| 8.6 | 0.66 |
| 8.7 | 0.61 |
| 8.8 | 0.57 |
| 8.9 | 0.53 |
| 9.0 | 0.50 |
| 9.1 | 0.46 |
| 9.2 | 0.42 |

*the voltage value which is measured when the standard electric current I_{c} (2.5 mA/cm²) is input

The process of displaying an image on the display panel 20 will be explained using FIG. 3. Further, the heights of the image data (a) and the corrected image data (b) in FIG. 3, are shown as the input value (or the luminance value) regarding each pixel. The height of the output image data (c) in FIG. 3 represents the luminance of the output image data regarding each pixel.

In this embodiment, before the process of displaying the image is started, (namely, after the power supply is switched on), the estimated luminous efficiency and the correction data are calculated as described above. Namely, the voltage value of each of the unit EL devices is measured so as to obtain the electric resistance value thereof, before the process of displaying the image is started. For example, if the measured voltage value of the unit EL devices E11, E12, . . . , and Enm are 8.0V, 9.0V, . . . , and 8.4V when the standard electric current I_{c} is input therein, the estimated luminous efficiency is respectively estimated to the 0.89, 0.50, . . . and 0.70 referring Table 2.

Next, the correction data (β) of each of the unit EL devices E11-Enm is calculated from the estimated luminous efficiency, so as to increase the unit quantity of electricity which is input to the unit EL devices having a relatively low luminous efficiency. Accordingly, the correction data (β) regarding each unit EL device E11-Enm is determined to be a value which is in inverse proportion to the estimated luminous efficiency, for example. Namely, the correction data regarding each the unit EL device E11, E12, . . . and Enm is determined to be 1.00, 1.78, . . . , and 1.27 for example.

The input image data (a) of each pixel is multiplied by the correction data (β) so as to be converted to the corrected image data (b). Due to this, the input value of the corrected image data (b) of each pixel is proportionally increased, according to the estimated luminous efficiency of each pixel. A unit quantity of electricity which is in proportion to the input value of the corrected image data (b), is input to each unit EL device E11-Enm.

Due to this, the unit quantity of electricity which is input to the unit EL device having a relatively low luminous efficiency, is relatively increased. Similarly, the unit quantity of electricity which is input to a unit EL device having relatively high luminous efficiency is relatively decreased. Accordingly, the output image data (c) which is displayed on the display panel 20 is uniform in luminance.

In this embodiment, the lowest resistance pixel having the lowest resistance value (namely, having the highest luminous efficiency) is determined to be the standard pixel, so the correction data of the lowest resistance pixel is determined to be 1.00, and the image data (a) of the lowest resistance pixel is not corrected. Namely, the correction data is determined so that the unit quantity of electricity of the high resistance pixel is increased as shown in FIG. 3.

Of course, the highest resistance pixel having the highest resistance value can be determined to be the standard pixel, so the highest resistance pixel may not be corrected. Namely, the correction data (value) is determined so that the unit quantity of electricity off the low resistance pixel is decreased.

Further, the average of the estimated luminous efficiency of all the pixels (all the unit EL devices) is calculated, and the pixel having the closet estimated luminous efficiency to the average can be determined to be the standard pixel. In this case, the unit quantity of electricity which is input to the standard pixel is not corrected. On the other hand, the unit quantity of electricity which is input to the high resistance pixel having a higher resistance value than the standard pixel is increased, and the unit quantity of electricity which is input to the low resistance pixel having a lower resistance value than the standard pixel is decreased.

Namely in this embodiment, the unit EL device having a relatively low luminous efficiency is defined as a high resistance pixel having a relatively high electric resistance value, and the unit EL device having a relatively high luminous efficiency is defined as a low resistance pixel having a relatively low electric resistance value.

Then, when the measuring circuit 15 detects a high resistance pixel, the unit quantity of electricity which is input to the high resistance pixel is increased relative to the unit quantity of electricity input to the low resistance pixel. Similarly, when the measuring circuit 15 detects a low resistance pixel, the unit quantity of electricity which is input to the low resistance pixel in decreased relative to the unit quantity of electricity input to the high resistance pixel.

Furthermore, the corrected image data (b) is calculated by multiplying the image data (a) and the correction data (β) in this embodiment. However, the corrected image data (b) may be calculated by other processes, for example by adding the correction data (β) to the image data (a), by subtracting the correction data (β)from the image data (a), by dividing the image data (a) by the correction data (β), and so on, so that the unit quantity of electricity which is input to the pixel having a lower luminous efficiency is relatively increased.

In this embodiment, the estimated luminous efficiency of the unit EL device is estimated by measuring the voltage value when the standard electric current I_{c} is input to the unit EL device. However, the estimated luminous efficiency of the unit EL device may be estimated by another process, for example by measuring the electric current value when the standard electric voltage is applied to the unit EL device so that the electric resistance of the unit EL device can be substantially measured.

Further, in this embodiment, the estimated luminous efficiency is estimated by finding a voltage value in Table 2 which corresponds to the measured voltage value and by determining the estimated luminous efficiency in Table 2 which corresponds to the found voltage value. However, if the voltage value which is identified as the measured voltage is not listed on Table 2, the estimated luminous efficiency is estimated by finding the voltage value in Table 2 which is closest to the measured voltage value, and by carrying out an approximate calculation using the found voltage value.

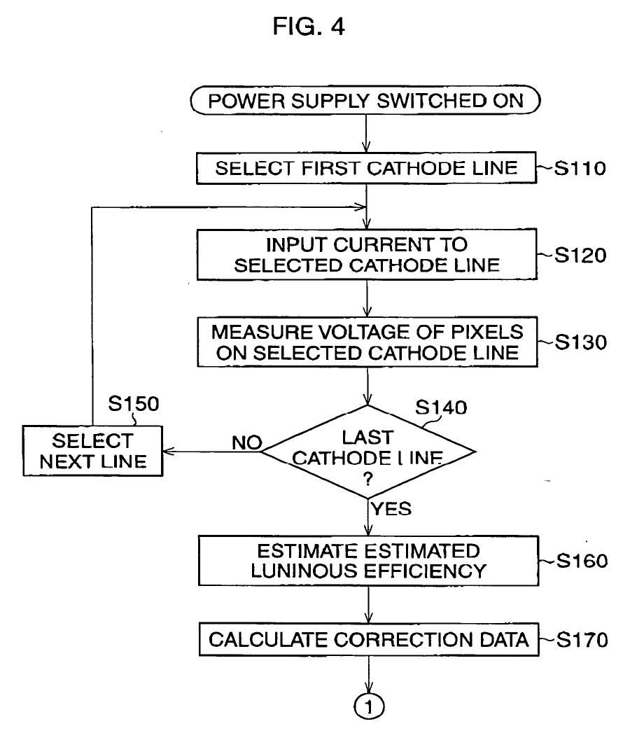

FIG. 4 is flowchart showing the routine for calculating the correction data. This routine is started when the power supply to the light emitting display device 10 is switched on. If this routine is started, the first cathode line B1 is selected as the selected cathode line Bx from the plurality of cathode lines B1-Bm, so that electric current can then flow through the first cathode line B1 by the first switch Sw_{B1}. At step S120, the switches Sw_{B1}-Sw_{Bm} which are provided on the anode lines A1-An are switched on, so the standard electric current I_{c} is input to all the unit EL devices E1x-Enx which are connected to the selected cathode line ax. At step S130, the potential difference between two points P_{Bx}-P_{A1}, P_{Bx}-P_{A2}, . . . , and P_{Bx}-P_{An} is measured by the measuring circuit 14, so that the voltage values of the unit EL device E1x-Enx on the selected cathode line Bx are obtained.

At step S140, it is determined whether the voltage values of all the unit EL devices E11-Enm are measured. Namely, it is determined whether the selected cathode line Bx is the last cathode line Bm. If the selected cathode line Bx is not the last cathode line Bm, the routine goes to step S150. If it is the last cathode line Bm, the routine goes to step S160. At step S150, the next cathode line Bx+1 is selected. For example, when the first cathode line B1 is currently selected, the second cathode line at B2 is selected at step S150. After stop S150 the routine goes back to step S120. Thus, steps S120-S150 are repeated, and then if the voltage values of all the unit EL devices E11-Enm are measured the routine goes to step S160.

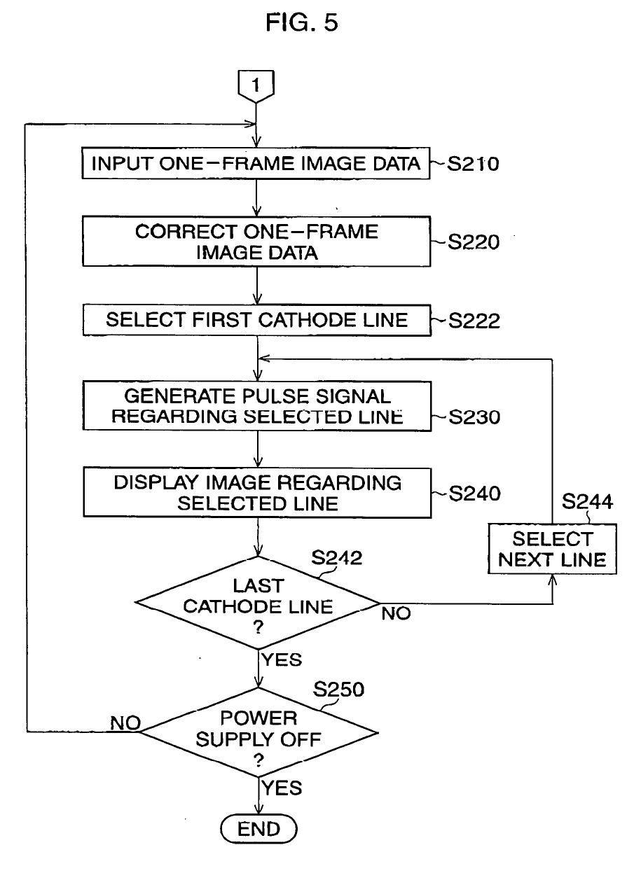

At step S160, the estimated luminous efficiency regarding all the unit EL devices E11-Enm is estimated using Table 2 from the voltage values which are measured at step S130. Next, at step S170, the correction data (β) regarding all the unit EL devices are calculated from the estimated luminous efficiency which is obtained at step S160. In this embodiment, the correction data (β) are in inverse proportion to the estimated luminous efficiency, and the correction data (β) regarding one of the unit EL devices E11-Enm having the highest estimated luminous efficiency is determined to be 1.00, and the correction data (β) regarding the other unit EL devices are determined to be more than 1.00. Namely, the image data of the unit EL device having the highest estimated luminous efficiency is not corrected at step S220 as shown in FIG. 5. After all of the correction data is calculated at step S170, the routine for calculating the correction data is finished and then the routine enters the routine for displaying the image data on the display panel 20.

FIG. 5 is the flowchart showing the routine for displaying the image data on the display panel. Further, this routine is for displaying the ordinal moving image on the display panel 20 For example, if the light emitting display device 10 is provided on a digital camera, this routine can be used for displaying the through image.

At step S210, one-frame image data which consists of image data regarding all the pixels is input to the correction circuit 15. Next, the input image data of each pixel is multiplied by the correction value of each pixel which is calculated at step S170, so as to correct the one-frame image data. Next, the first cathode line B1 is selected at step S222. After step S222, the pulse signals for displaying the one-line image regarding the selected cathode line Bx are generated based on the corrected image signal (b) at a pulse generating circuit (not shown in Figs.) of the emission controlling circuit 16. At step S240, the pulse signals are input to the unit EL devices E1x-Enx, and then the one-line image regarding the selected cathode line Bx is displayed on the display panel 20.

After displaying the one-line image, it is determined whether the selected cathode line Bx is the last cathode line Bm at step S242. If the selected cathode line Bx is not the last cathode line Bm, the routine goes to step S244, and then the next cathode line Bx+1 is selected at step S244 because the one-frame image data has not been displayed yet. After finishing step S244 the routine goes back to step S230. At step S230, the pulse signals regarding the next selected cathode line Bx+1 are generated at step S230 and the one-line image regarding the selected cathode line Bx+1 is displayed on the display panel 20 at step S240. Due to repeating these routines at steps S230-S244, the line images from the first cathode line B1 to the last cathode line Bm are displayed.

At step S242, if it is determined that the selected cathode line Bx is the last cathode line Bm, the routine goes to step S250, because the display of the one-frame image data has finished.

At step S250, it is determined whether the power supply to the light emitting display device 10 is switched off. If the power supply is switched off, this routine is finished. If the power supply is not switched off, the routine goes back to step S210 and the next one-frame image is displayed on the display panel 20.

In the first embodiment, the method of driving the EL display device is the passive matrix driving method, but it can be the active matrix driving method.

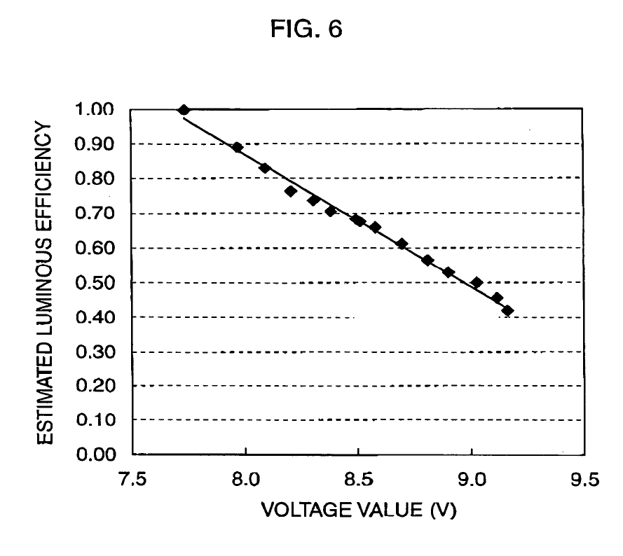

In the first embodiment, the relation between the electric resistance (the voltage value when the standard electric current I_{c} is input) and the luminous efficiency is stored as the table; Table 2. However, the relation between the electric resistance and the luminous efficiency can be stored as the function y=f(x) as shown in FIG. 6.

In this function y=f(x), “x” is the voltage value of the unit EL device when the standard electric current I_{c} is input thereto, namely “x” means the electric resistance and “y” is the estimated luminous efficiency of the unit EL device having the electric resistance corresponding to “x”.

Therefore, if the function y=f(x) is used to estimate the estimated luminous efficiency, the voltage value which is measured at step S130 (as shown in FIG. 4) is substituted for “x” at step S160, so as to calculate the estimated luminous efficiency as “y” regarding each pixel.

Further, the function f(x) is calculated and is stored in the memory 17, when the light emitting display device 10 is being manufactured, similar to Table 2 for example. Furthermore, the estimated luminous efficiency is in proportion to the electric resistance (namely the voltage value of the unit EL device when the standard electric current I_{c} is input thereto) therefore, the function f(x) is a linear function which is calculated by the least square method.

Although the embodiments of the present invention have been described herein with reference to the accompanying drawings, obviously many modifications and changes can be made by those skilled in this art without departing from the scope of the invention.

The present disclosure relates to subject matter contained in Japanese Patent Application No. 2004-378966 (filed on Dec. 28, 2004) which is expressly incorporated herein, by reference, in its entirety.

1. A light emitting display device, comprising.
a display panel comprising an emitting device which forms a plurality of pixels;
an input processor that inputs a unit quantity of electricity to each pixel of said plurality of pixels according to image data so that each pixel in said plurality of pixels emits a predetermined light, the luminance value of said predetermined light per unit quantity of electricity being smaller as the electric resistance value of said each pixel becomes larger; and
a detecting processor that detects at least one of a high resistance pixel having a relatively high electric resistance and a low resistance pixel having a relatively low electric resistance among said plurality of pixels;
wherein said input processor adjusts said unit quantity of electricity for at least one of said high resistance pixel and said low resistance pixel, said unit quantity of electricity supplied to said high resistance pixel being increased relative to said unit quantity of electricity supplied to said low resistance pixel, or said unit quantity of electricity supplied to said low resistance pixel being decreased relative to said unit quantity of electricity supplied to said high resistance pixel.

2. A device according to claim 1, wherein said detecting processor measures said electric resistance of said each pixel, in order to detect at least one of said high resistance pixel and said low resistance pixel.

3. A device according to claim 2, wherein said detecting processor measures a voltage value of said each pixel so as to obtain said electric resistance value, when a standard electric current is input therein.

4. A device according to claim 2, wherein said detecting processor measures an electric current value of each pixel so as to obtain said electric resistance value, when a standard voltage is applied thereto.

5. A device according to claim 1, wherein said input processor increases said unit quantity of electricity in said high resistance pixel.

6. A device according to claim 1, wherein said input processor decreases said unit quantity of electricity in said low resistance pixel.

7. A device according to claim 1, wherein said input processor increases said unit quantity of electricity in said high resistance pixel, and decreases said unit quantity of electricity in said low resistance pixel.

8. A device according to claim 1, comprising, a memory that stores relation data between said luminance value and said electric resistance value.

9. A device according to claim 8, wherein said relation data is prior to operation of the device stored, said relation data being generated based on the luminance which is measured when the electric resistance value is changed.

10. A device according to claim 13, wherein said input processor adjusts said unit quantity of electricity, based on said relation data and said electric resistance value measured by said detecting processor, for said each pixel.

11. A device according to claim 8, wherein said luminance value, which corresponds to each said electric resistance value of said emitting device, is measured prior to operation of the device.

12. A device according to claim 1, comprising, a data generation processor that generates a correction value regarding said each pixel, said correction value being larger as said electric resistance value becomes larger,
wherein said unit quantity of electricity in each pixel, determined according to said image data, is multiplied by said correction value.

13. A device according to claim 1, wherein said unit quantity of electricity is a quantity of electricity input to said each pixel for a predetermined time.

14. A device according to claim 12, wherein said predetermined time is within a period where said display panel displays one-frame image.

15. A method of driving a light emitting display device, said light emitting display device comprising a display panel that has an emitting device which forms a plurality of pixels, the method comprising the steps of:
inputting a unit quantity of electricity in each pixel of said plurality of pixels according to image data so that said each pixel emits a predetermined light, the luminance of said predetermined light per unit quantity of electricity being smaller as the electric resistance value of said each pixel is larger;
detecting at least one of a high resistance pixel having a relatively high electric resistance value and a low resistance pixel having a relatively low electric resistance value among said plurality of pixels; and
adjusting said unit quantity of electricity for at least one of said high resistance pixel and said low resistance pixel, said unit quantity of electricity supplied to said high resistance pixel being increased relative to said unit quantity of electricity supplied to said low resistance pixel, or said unit quantity of electricity supplied to said low resistance pixel being decreased relative to said unit quantity of electricity supplied to said high resistance pixel.

16. A light emitting display device, comprising:
a display panel comprising an emitting device which forms a plurality of pixels;
an input processor that inputs a unit quantity of electricity to each pixel of said plurality of pixels according to image data so that said each pixel emits a predetermined light, the luminance of said predetermined light per unit quantity of electricity being smaller as the electric resistance value of said each pixel is larger; and
a detecting processor that measures an electric resistance value of each pixel of said plurality of pixels.
